(19) United States
(12) Patent Application Publication
(10) Pub. No.: US 2017/0248930 A1
(43) Pub. Date: Aug. 31, 2017

(54) COMPONENT TABLE MANAGEMENT SYSTEM AND COMPONENT TABLE MANAGEMENT METHOD

(71) Applicant: MITSUBISHI HEAVY INDUSTRIES, LTD., Tokyo (JP)

(72) Inventors: Hiroki KURAHASHI, Tokyo (JP); Masaki KASAHARA, Tokyo (JP); Yoshinori KATO, Tokyo (JP)

(21) Appl. No.: 15/518,620

(22) PCT Filed: Sep. 16, 2015
(86) PCT No.: PCT/JP2015/076300

§ 371 Date: Apr. 12, 2017

(30) Foreign Application Priority Data
Oct. 24, 2014 (JP) 2014-217200

(51) Int. Cl. G05B 19/042; G05B 19/418

(52) U.S. Cl. CPC G05B 19/0426; G05B 19/418

(57) ABSTRACT

A first storage unit stores a main component table holding design information of products. A second storage unit stores a sub-component table holding the design information of the products and an update deadline of the design information for each predetermined unit constituted by products manufactured on the basis of the same design information. A first determination unit determines whether or not the main component table has been changed. A second determination unit determines whether or not a present date is before the update deadline. The second determination unit reflects contents of the change performed on the main component table on the sub-component table in a case where the main component table has been changed and the present date is before the update deadline.

### TECHNICAL FIELD

The present invention relates to a technique for managing information regarding the production of a product.

Priority is claimed based on Japanese Patent Application No. 2014-217200 filed on Oct. 24, 2014, the content of which is incorporated herein by reference.

### BACKGROUND ART

In the recent years, product management using a component table called a bill of materials (BOM) has been performed in the scene of the manufacturing industry. The BOM holds a hierarchical structure of components constituting a product, the number of components, and other pieces of design information. The BOM is used in various modes in accordance with use scenes or purposes. Examples of the BOM include an engineering BOM (E-BOM) which is used for design in a design category and a manufacturing BOM (M-BOM) which is used for the manufacture and assembling of a product in a manufacturing category. PTL 1 discloses a technique for keeping an E-BOM in a state where the latest design information is reflected thereon at all times.

According to PTL 1, a component table management system associates a version number given by the revision of a design drawing with item data. The item data is information indicating attributes of components constituting a product. The item data is information which is a constituent element of the E-BOM. The component table management system keeps an up-to-date state of the E-BOM by updating a correspondence relation between the version number of the drawing and the item data at all times.

### CITATION LIST

### Patent Literature

[PTL 1] Japanese Examined Patent Application Publication No. 3-15223

### SUMMARY OF INVENTION

### Technical Problem

However, it may be difficult for a user to ascertain contents of a change in design which was performed in the past.

An object of the invention is to provide a component table management system making a user easily ascertain contents of a change in design which was performed in the past.

### Solution to Problem

A component table management system according to an aspect of the invention includes a first storage unit, a second storage unit, a first determination unit, and a second determination unit. The first storage unit stores a main component table holding design information of products. The second storage unit stores a sub-component table holding the design information of the products and an update deadline of the design information for each predetermined unit constituted by the products manufactured on the basis of the same design information. The first determination unit determines whether or not the main component table has been changed. The second determination unit determines whether or not a present date is before the update deadline. The second determination unit reflects contents of the change performed on the main component table on the sub-component table in a case where all of the following conditions are satisfied. One of the conditions is that the first determination unit determines that the main component table has been changed. The other is that the second determination unit determines that the present date is before the update deadline.

The above-described component table management system may further include a third determination unit. The third determination unit may determine whether or not permission information for permitting a change after the update deadline has been input to the sub-component table. The third determination unit may reflect contents of the change performed on the main component table on the sub-component table in a case where all of the following conditions are satisfied. One of the conditions may be that the first determination unit determines that the main component table has been changed. Another one of the conditions may be that the second determination unit determines that the present date is after the update deadline. Still another one of the conditions may be that the third determination unit determines that the permission information has been input.

In the above-described component table management system, the sub-component table may hold information regarding a version number of the design information.

In the above-described component table management system, the second storage unit may store the sub-component table for each individual of the products.

In the above-described component table management system, the second storage unit may store the sub-component table for each lot of the products.

The above-described component table management system may further include a providing unit. The providing unit may provide information held in the main component table or the sub-component table to an external system.

A component table management method according to another aspect of the invention is performed by a component table management system including a first storage unit and a second storage unit. The first storage unit stores a main component table holding design information of products. The second storage unit stores a sub-component table holding the design information of the products and an update deadline of the design information for each predetermined unit constituted by the products manufactured on the basis of the same design information. The component table management method includes a first determination step, a second determination step, and a reflection step. The first determination step is a step of determining whether or not the main component table has been changed. The second determination step is a step of determining whether or not a present date is before the update deadline. The reflection step is a step of reflecting contents of the change performed on the main component table on the sub-component table in a case where it is determined that the main component table has been changed and it is determined that the present date is before the update deadline.

### Advantageous Effects of Invention

A user can easily ascertain contents of a change in design which was performed in the past by at least one of the above-described aspects.

### BRIEF DESCRIPTION OF DRAWINGS

FIG. 1 is a schematic diagram illustrating an application example of a component table management system according to an embodiment.

FIG. 2 is a functional block diagram illustrating a functional configuration of the component table management system according to the embodiment.

FIG. 3A is a diagram illustrating a specific example of an E-BOM according to the embodiment.

FIG. 3B is a diagram illustrating a specific example of an E-BOM according to the embodiment.

FIG. 4A is a diagram illustrating a specific example of a serial number BOM according to the embodiment.

FIG. 4B is a diagram illustrating a specific example of a serial number BOM according to the embodiment.

FIG. 4C is a diagram illustrating a specific example of a serial number BOM according to the embodiment.

FIG. 5 is a time chart illustrating a specific example of a manufacturing schedule of a product according to the embodiment.

FIG. 6 is a flow chart illustrating a flow of a process of updating a serial number BOM in the component table management system according to the embodiment.

FIG. 7 is a diagram illustrating an operation example of the component table management system according to the embodiment.

FIG. 8 is a diagram illustrating an operation example of the component table management system according to the embodiment.

### DESCRIPTION OF EMBODIMENTS

Hereinafter, a component table management system according to the embodiment will be described with reference to the accompanying drawings.

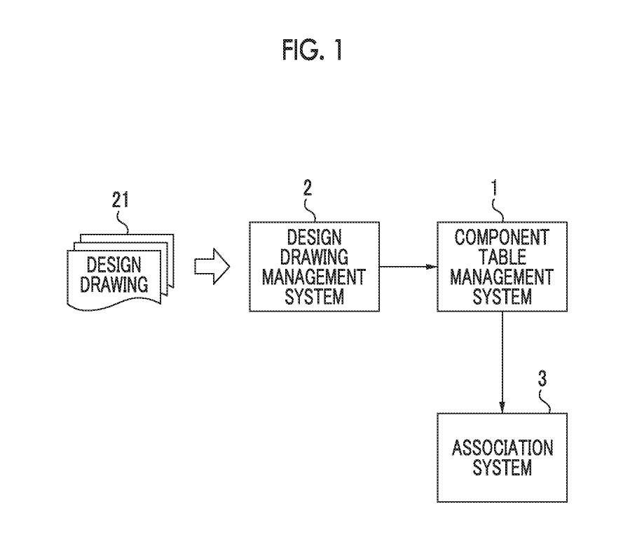

FIG. 1 is a schematic diagram illustrating an application example of a component table management system 1 according to an embodiment

The component table management system 1 acquires information regarding the design of a product to be managed (hereinafter, referred to as “design information”) from a design drawing management system 2. The component table management system 1 generates item data and configuration data from the design information. The component table management system 1 registers the item data and the configuration data in an E-BOM. The item data is information indicating a list of all components constituting the product. The configuration data is information indicating a master-slave relationship between the components included in the item data. For example, in a case where a component A is constituted by a component B and a component C, configuration data indicates that the component A is a master item of the component B and the component C, and the component B and the component C are slave items of the component A. The component table management system 1 provides design information managed in the E-BOM to an association system 3.

The design drawing management system 2 is a system for managing a design drawing. The design drawing management system 2 receives an input of registration or an input of correction of a design drawing 21. The design drawing management system 2 notifies the component table management system 1 that an input related to the design drawing 21 is received. The design drawing management system 2 outputs design information written in the design drawing 21 to the component table management system 1 in response to a request of the component table management system 1.

The association system 3 is a general term for external systems that perform a process using design information. The number of external systems included in the association system 3 may be one or may be two or more. For example, the association system 3 includes a system in a business category, a system in a design category, a system in a supply category, a system in a quality control category, a system in a manufacturing category, a system in an after-sales service category, or other systems.

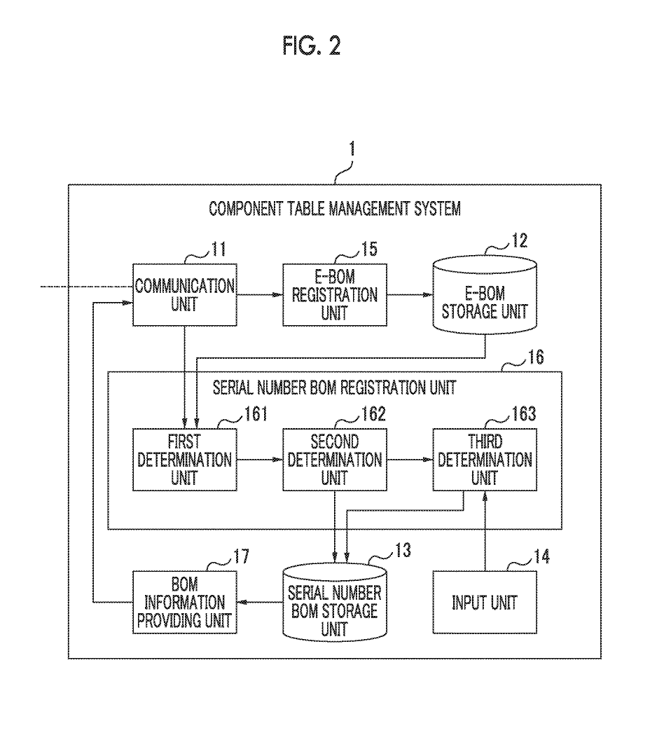

FIG. 2 is a functional block diagram illustrating a functional configuration of the component table management system 1.

The component table management system 1 includes a central processing unit (CPU), a memory, an auxiliary storage device, and other devices which are connected to each other through a bus. The component table management system 1 executes a component table management program. The component table management system 1 functions as an apparatus including a communication unit 11, an E-BOM storage unit 12, a serial number BOM storage unit 13, an input unit 14, an E-BOM registration unit 15, a serial number BOM registration unit 16, and a BOM information providing unit 17 by the execution of the component table management program. All or a portion of the functions of the component table management system 1 may be realized using hardware such as an application specific integrated circuit (ASIC), a programmable logic device (PLD), or a field programmable gate array (FPGA). The component table management program may be recorded in a computer-readable recording medium. The recording medium may not be a transitory medium. Examples of the computer-readable recording medium include a flexible disc, a magneto-optical disc, a ROM, a CD-ROM, a hard disk built into a computer system, and other storage devices. The component table management program may be transmitted to the component table management system 1 through an electric communication line.

The communication unit 11 includes a communication interface such as a local area network (LAN). The communication unit 11 communicates with the design drawing management system 2 and the association system 3.

An E-BOM storage unit 12 (first storage unit) includes a magnetic hard disk device, a semiconductor memory device, or other storage devices. The E-BOM storage unit 12 stores an E-BOM 121.

A serial number BOM storage unit 13 (second storage unit) includes a magnetic hard disk device, a semiconductor memory device, or other storage devices. The serial number BOM storage unit 13 stores serial number BOMs 131-1 to 131-n (n is an integer of 1 or greater).

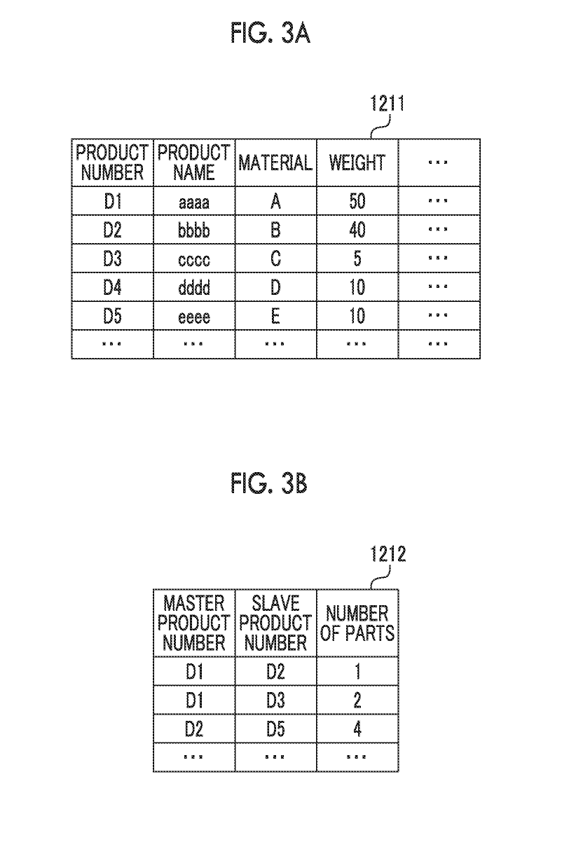

FIG. 3A is a diagram illustrating a specific example of a product number master 1211 of the E-BOM 121. FIG. 3B is a diagram illustrating a specific example of a configuration master 1212 of the E-BOM 121.

The E-BOM 121 (main component table) is a database for managing all components of a product to be produced. The E-BOM 121 includes the product number master 1211 and the configuration master 1212.

The product number master 1211 includes a product number record for each product number. The product number record includes values of a product number and attribute information of a component. The product number is identification information of the component. Examples of the attribute information of the component include a component name, a material, and weight. The configuration master 1212 includes a configuration record for each master product number. The configuration record includes values of a master product number, a slave product number, and the number of parts. The master product number is a product number of a master component. The slave product number is a product number of a slave component. The number of parts indicates the number of slave components required to form one master component. The product number record and the configuration record are registered or updated by the E-BOM registration unit 15.

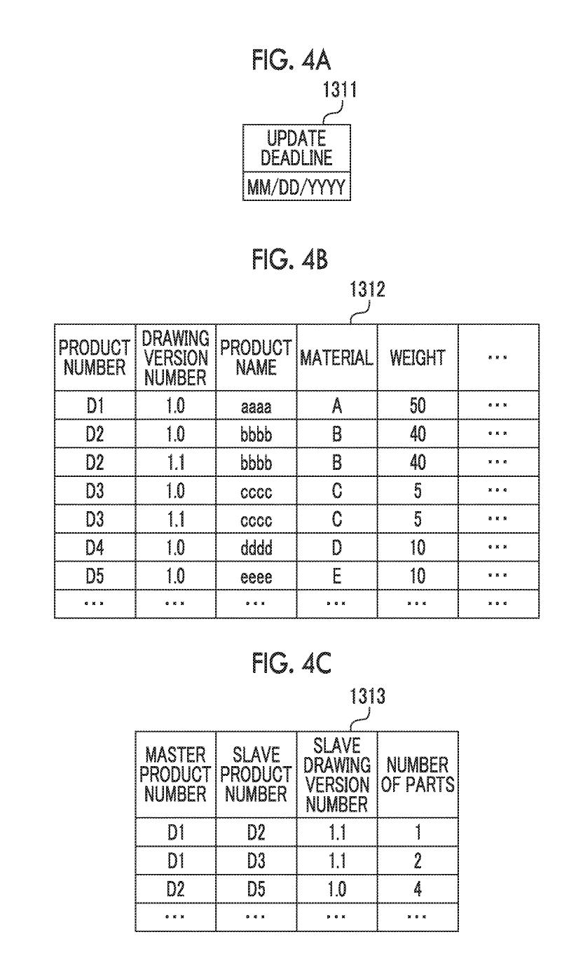

FIG. 4A is a diagram illustrating a specific example of an update deadline master 1311 of a serial number BOM 131. FIG. 4B is a diagram illustrating a specific example of a product number version number master 1312 of the serial number BOM 131. FIG. 4C is a diagram illustrating a specific example of a serial number configuration master 1313 of the serial number BOM 131.

The serial number BOM 131 (sub-component table) is a database for managing a component table for each serial number (individual) with respect to a product to be produced. The serial number BOM 131 includes the update deadline master 1311, the product number version number master 1312, and the serial number configuration master 1313. For example, in a case where production by order for a certain vehicle is performed, serial number BOMs 131 corresponding to the number of vehicles for which the order has been received are registered in the serial number BOM storage unit 13 in advance. Specifically, in a case where production by order for n (n is an integer of 1 or greater) vehicles is performed, serial number BOMs 131-1 to 131-n which are n serial number BOMs 131 are registered in the serial number BOM storage unit 13 in advance. In this case, information registered in the product number version number master 1312 is the same as those in the serial number BOMs 131-1 to 131-n. For this reason, one product number version number master 1312 may be shared by the serial number BOMs 131-1 to 131-n. In a case where the update deadline master 1311, the product number version number master 1312, and the serial number configuration master 1313 include an item indicating identification information of a serial number to be managed, the serial number BOMs 131-1 to 131-n may be configured as a serial number BOM constituted by one table.

The update deadline master 1311 includes one update deadline record having a value of an update deadline. The update deadline represents a termination date of a period of time for which the updating of the serial number BOM 131 is permitted. That is, the update deadline master 1311 included in each of the serial number BOMs 131-1 to 131-n represents an update deadline of each of the serial number BOMs 131-1 to 131-n.

The product number version number master 1312 includes a product number version number record for each product number. The product number version number record includes values of a product number, a drawing version number, and attribute information of a component. The values of the product number and the attribute information of the component are the same as the values of the product number and the attribute information of the component of the product number record of the E-BOM 121. The drawing version number indicates a version number of a drawing when the serial number BOM 131 is registered or updated. That is, the drawing version number represents a version of design when the serial number BOM 131 is registered or updated.

The serial number configuration master 1313 includes a serial number configuration record for each master product number. The serial number configuration record includes values of a master product number, a slave product number, a slave drawing version number, and the number of parts. The values of the master product number, the slave product number, and the number of parts are the same as the values of the master product number, the slave product number, and the number of parts of the configuration record of the E-BOM 121. The slave drawing version number is a drawing version number of a component indicated by the slave product number.

The update deadline record is registered in advance by a manager of the component table management system 1. The product number version number record and the serial number configuration record are registered or updated by the serial number BOM registration unit 16.

The input unit 14 receives an input of a change measure label. The change measure label (permission information) is information which is input in a case where the serial number BOM 131 is changed after the update deadline of the serial number BOM 131. The input unit 14 includes a mouse, a keyboard, or other input devices. The input unit 14 outputs the input change measure label to a third determination unit 163.

The E-BOM registration unit 15 registers or updates the E-BOM 121 on the basis of the design information which is output from the design drawing management system 2. In a case where the design information indicates a new design, the E-BOM registration unit 15 registers design contents indicated by the design information in the E-BOM 121. In a case where the design information indicates a change in the existing design, the E-BOM registration unit 15 updates the E-BOM 121 on the basis of change contents indicated by the design information.

The serial number BOM registration unit 16 registers or updates the serial number BOM 131 on the basis of the E-BOM 121. The serial number BOM registration unit 16 includes a first determination unit 161, a second determination unit 162, and a third determination unit 163.

The first determination unit 161 (first determination unit) monitors a change for the E-BOM 121. In a case where a change occurs in the E-BOM 121, the first determination unit 161 notifies the second determination unit 162 of the occurrence of the change. Hereinafter, the notification of the change occurring in the E-BOM 121 will be referred to as a change notification. The first determination unit 161 performs a change notification and outputs change contents of the E-BOM 121 to the second determination unit 162.

When the second determination unit 162 (second determination unit) receives the change notification, the second determination unit determines whether or not the present date managed by the device is before the update deadline of the serial number BOM 131 to be updated. In a case where the present date is before the update deadline of the serial number BOM 131 to be updated, the second determination unit 162 updates the target serial number BOM 131 on the basis of the change contents which are output from the first determination unit 161. On the other hand, in a case where the present date is after the update deadline of the serial number BOM 131 to be updated, the second determination unit 162 gives a change notification to the third determination unit 163 and outputs change contents to the third determination unit 163.

The third determination unit 163 (third determination unit) updates the serial number BOM 131 on the basis of the change measure label. Specifically, when the third determination unit 163 receives the change notification from the second determination unit 162, the third determination unit determines whether or not a change measure label is input. In a case where the change measure label is input from the input unit 14, the third determination unit 163 determines that a change after an update deadline is permitted, and updates the target serial number BOM 131 on the basis of the change contents which are output from the second determination unit 162. In a case where the change measure label is not input from the input unit 14, the third determination unit 163 determines that a change after the update deadline is not permitted, and does not update the serial number BOM 131.

The BOM information providing unit 17 acquires information of the serial number BOM 131 from the serial number BOM storage unit 13, and transmits the acquired information of the serial number BOM 131 to the association system 3 through the communication unit 11.

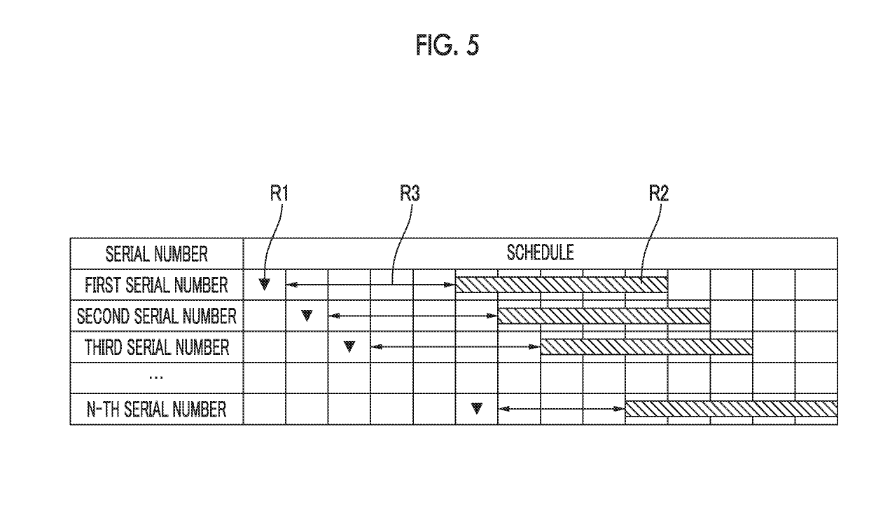

FIG. 5 is a time chart illustrating a specific example of a manufacturing schedule of a product.

FIG. 5 illustrates an instruction date of component arrangements (arrangement instruction date R1) in a production schedule for each serial number, and a manufacturing period R2. A period of time between the arrangement instruction date R1 and the manufacturing period R2 is a component lead time R3. The component lead time R3 is a period of time required until a component instructed for arrangement arrives at the scene of manufacture. In a case where a product is manufactured according to such a schedule, an update deadline of the serial number BOM 131 is set, for example, in the arrangement instruction date R1. The update deadline is set in the arrangement instruction date R1, and thus a change in design for each serial number is managed so as to be basically performed until the arrangement instruction date R1. In order to perform the change in design after the arrangement instruction date R1, a change measure label is required to be input. It is possible to suppress a delay in ordering of a component while securing a maximum design period by such management.

The update deadline may be set to a date other than the arrangement instruction date R1 in accordance with a production system. Examples of the update deadline include a design completion date (drawing release date) when the design of a serial number is completed, a manufacturing starting date, a date going back by a predetermined period of time with the manufacturing starting date as a starting point, and an ordering date of a component.

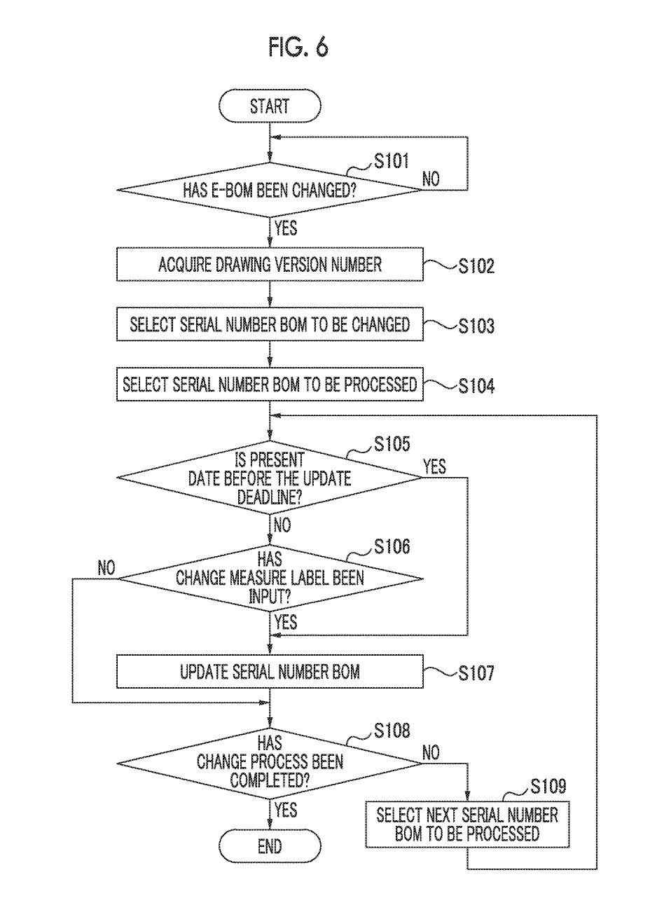

FIG. 6 is a flow chart illustrating a flow of a process of updating the serial number BOM 131 in the component table management system 1 according to the embodiment.

First, a change in a product drawing is registered in the design drawing management system 2 by a designer. The registration of the drawing is called the release of the drawing. The design drawing management system 2 notifies the component table management system 1 that the release of the drawing has been performed. The design drawing management system 2 outputs contents of a change in design to the component table management system 1. The E-BOM registration unit 15 acquires the contents of the change in design from the design drawing management system 2. The E-BOM registration unit 15 registers the acquired contents of the change in the E-BOM 121.

The first determination unit 161 of the serial number BOM registration unit 16 determines whether or not the E-BOM 121 has been changed (step S101). In a case where it is determined that the E-BOM 121 has not been changed (step S101: NO), the first determination unit 161 repeatedly performs the determination of step S101, and monitors whether or not the E-BOM 121 has been changed. On the other hand, in a case where it is determined that the E-BOM 121 has been changed (step S101: YES), the first determination unit 161 acquires a drawing version number of a released drawing from the design drawing management system 2 (step S102). The first determination unit 161 selects a changed configuration record and a changed product number record with reference to the E-BOM 121. The first determination unit 161 gives a change notification to the second determination unit 162. The first determination unit 161 outputs values of the selected configuration record, values of the selected product number record, and the acquired drawing version number to the second determination unit 162.

When the second determination unit 162 receives the change notification from the first determination unit 161, the second determination unit acquires values of the changed configuration record, values of the changed product number record, and the drawing version number from the first determination unit 161. The second determination unit 162 selects the serial number BOM 131 in which the value of a product number of a product number version number record indicates the same value as that of a product number of the acquired product number record, with reference to the serial number BOMs 131 of the respective serial numbers. The second determination unit 162 selects the serial number BOM 131 in which the value of a master product number of a serial number configuration record indicates the same value as that of a master product number of the acquired configuration record and the value of a slave product number of the serial number configuration record indicates the same value as that of a slave product number of the configuration record, with reference to the serial number BOMs 131 of the respective serial numbers. The second determination unit 162 sets the selected serial number BOM 131 to be a serial number BOM 131 to be changed (step S103). The second determination unit 162 selects an update deadline record of the serial number BOM 131 to be changed (step S104). The second determination unit 162 acquires a value of an update deadline from the selected update deadline record. The second determination unit 162 determines whether or not the present date is a date before the update deadline (step S105).

In a case where it is determined that the present date is a date after the update deadline (step S105: NO), the second determination unit 162 gives a change notification to the third determination unit 163. The second determination unit 182 outputs values of the changed configuration record, values of the changed product number record, and the drawing version number to the third determination unit 163. When the third determination unit 163 receives the change notification from the second determination unit 162, the third determination unit acquires the values of the changed configuration record, the values of the changed product number record, and the drawing version number from the second determination unit 162. The third determination unit 163 determines whether or not a change measure label has been input (step S105).

In a case where it is determined that the change measure label has been input (step S106: YES), the third determination unit 163 determines that a change in the serial number BOM 131 after the update deadline has been permitted. The third determination unit 163 updates the selected serial number BOM 131 on the basis of the values of the changed configuration record, the values of the changed product number record, and the drawing version number (step S107). Specifically, the third determination unit 163 generates a product number version number record from the values of the changed product number record and the drawing version number. The third determination unit 163 registers the generated product number version number record in the product number version number master 1312. The third determination unit 163 generates a serial number configuration record from the values of the changed configuration record and the drawing version number. The third determination unit 163 registers the generated serial number configuration record in the serial number configuration master 1313.

On the other hand, in a case where it is determined in step S105 that the present date is a date before the update deadline (step S105: YES), the second determination unit 162 causes the processing to proceed to step S107. That is, the second determination unit 162 updates the selected serial number BOM 131 on the basis of the values of the changed configuration record, the values of the changed product number record, and the drawing version number without giving a change notification to the third determination unit 163.

On the other hand, in a case where it is determined in step S106 that the change measure label has not been input (step S106: NO) or it is determined in step S107 that the serial number BOM 131 has been updated, the second determination unit 162 determines whether or not a change process has been completed with respect to all of the serial number BOMs 131 selected as objects to be processed (step S108). The completion of the change process includes determining that the present date is after the update deadline of the serial number BOM 131 and determining that the serial number BOM 131 is not updated due to the change measure label not being input.

In a case where it is determined that there is an unprocessed serial number BOM 131 among all of the serial number BOMs 131 selected as objects to be processed (step S108: NO), the second determination unit 162 selects the next serial number BOM 131 to be processed among all of the serial number BOMs 131 selected as objects to be processed (step S109). The second determination unit 162 causes the processing to proceed to step S105 and repeatedly performs the subsequent processes. On the other hand, in a case where it is determined that the change process has been completed with respect to all of the serial number BOMs 131 selected as objects to be processed (step S108: YES), the second determination unit 162 terminates the processing.

In the above-described flow chart, a description has been given of a case where both the product number master 1211 and the configuration master 1212 have been changed in the E-BOM 121, but the change in the E-BOM 121 may be a change in only one of the product number master 1211 and the configuration master 1222. The change in the E-BOM 121 may be a change in the existing record, or may be the registration of a new record. Even when the change in the E-BOM 121 is either the change in the existing record or the registration of a new record, contents of the change in the E-BOM 121 are stored for each drawing version number in the serial number BOMs 131 of the respective serial numbers.

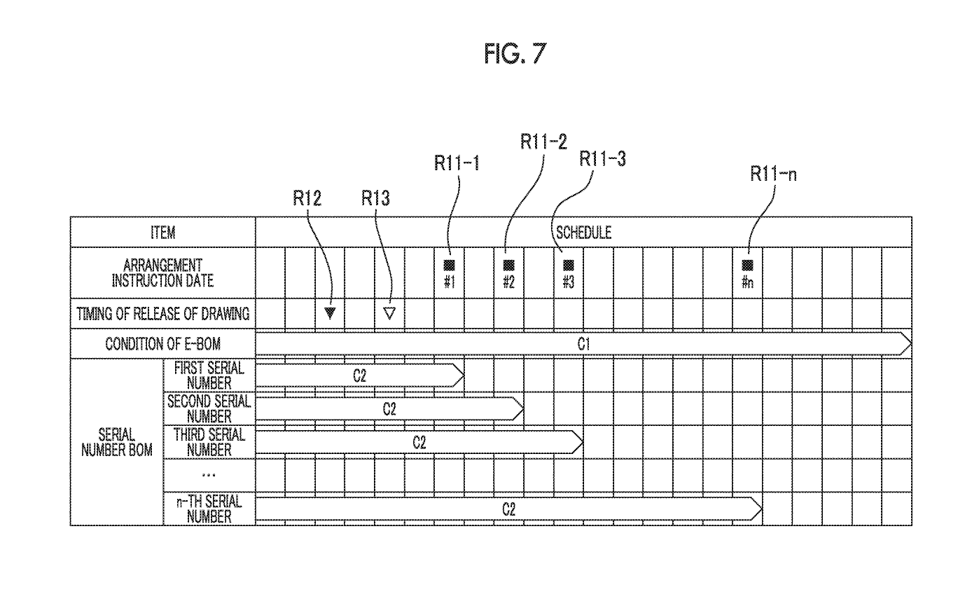

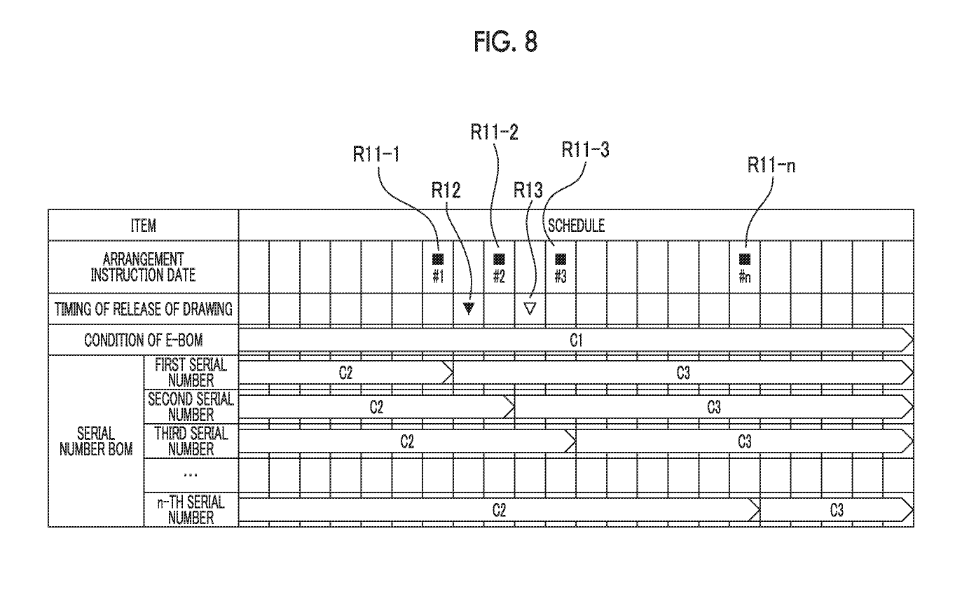

FIGS. 7 and 8 are diagrams illustrating an operation example of the component table management system 1 according to the embodiment.

In the examples illustrated in FIGS. 7 and 8, update deadlines of respective serial numbers are set on arrangement instruction dates R11-1 to R11-n of the respective serial numbers. In the example illustrated in FIG. 7, release R12 of a new drawing and release R13 of a corrected drawing are performed before the arrangement instruction date R11-1 of a first serial number. In the examples illustrated in FIGS. 7 and 8, the condition of the E-BOM 121 is a condition C1 in which the latest information is reflected at all times. In the examples illustrated in FIGS. 7 and 8, the condition of each of the serial number BOMs 131-1 to 131-n until the arrangement instruction dates R11-1 to R11-n is a condition C2 in which information of the E-BOM 121 is automatically reflected. In the examples illustrated in FIGS. 7 and 8, the condition of each of the serial number BOMs 131-1 to 131-n after the arrangement instruction dates R11-1 to R11-n is a condition C3 in which a change measure label is required to reflect the information of the E-BOM 121.

In the example illustrated in FIG. 8, the release R12 of the new drawing is performed at a timing between the arrangement instruction date R11-1 of the first serial number and the arrangement instruction date R11-2 of a second serial number. In the example illustrated in FIG. 8, the release R13 of the corrected drawing is performed at a timing between the arrangement instruction date R11-2 of the second serial number and the arrangement instruction date R11-3 of a third serial number.

In a case of the example illustrated in FIG. 7, the release of the new drawing and the release of the corrected drawing are performed before the arrangement instruction date of the first serial number which is the earliest update deadline. For this reason, a change in the E-BOM 121 due to the release of the drawings is automatically reflected on the serial number BOMs 131-1 to 131-n of the respective serial numbers.

On the other hand, in a case of the example illustrated in FIG. 8, the release of the new drawing is performed after the arrangement instruction date of the first serial number which is the update deadline of the first serial number and before the arrangement instruction date of the second serial number which is the update deadline of the second serial number. For this reason, a change in the E-BOM 121 due to the release of the new drawing is automatically reflected on the serial number BOMs 131-2 to 131-n in the second to n-th serial numbers, but a change measure label is required for reflection on the serial number BOM 131-1 of the first serial number.

In a case of the example illustrated in FIG. 8, the release of the corrected drawing is performed after the arrangement instruction date of the second serial number which is the update deadline of the second serial number and before the arrangement instruction date of the third serial number which is the update deadline of the third serial number. For this reason, a change in the E-BOM 121 due to the release of the corrected drawing is automatically reflected on the serial number BOMs 131-3 to 131-n in the third to n-th serial numbers, but a change measure label is required for reflection on the serial number BOMs 131-1 and 131-2 of the first and second serial numbers.

In a case where a large-scale change in design (hereinafter, referred to as “major change”) such as a change in product specifications has been recently performed in the management of a component table using an E-BOM system, an E-BOM after the change is managed as an E-BOM different from the original E-BOM. For this reason, a user of a component table management system can acquire pieces of information before and after the change in design from the respective E-BOMs.

However, in a case where a small-scale change in design (hereinafter, referred to as “minor change”) which maintains compatibility is performed, an E-BOM after the change in design is managed as the same E-BOM as the original E-BOM. For this reason, information of the E-BOM before the change in design is replaced with design information after the change in design. This is because the E-BOM holds only the latest information at all times. For this reason, there is a possibility that it is difficult for a user of a component table management system to acquire information regarding the E-BOM before the change in design after the design is changed.

In the component table management system 1 according to the embodiment which is configured in the above-described manner, a component table of each serial number is managed as a serial number BOM on the basis of an E-BOM. The serial number BOM includes a drawing version number and holds an E-BOM regarding each serial number. For this reason, a user of the component table management system can easily ascertain contents of a change in design which was performed in the past.

Hereinafter, a description will be given of a specific example of an advantage brought to the association system 3 by using the component table management system 1 according to the embodiment.

For example, in a case where the association system 3 is a system in a design category, a person in charge of the design category can easily acquire not only a manufacturing cost of each serial number but also a manufacturing cost in units of a part or a component by associating information regarding the cost of each component and the serial number BOM 131 with each other. Thereby, the person in charge of the design category can easily perform comparison and analysis of fluctuations in a manufacturing cost accompanied by a change in design.

For example, in a case where the weight of a product is an important design matter, the person in charge of the design category can manage the design weight of each serial number in detail by associating information regarding the weight of each component and the serial number BOM 131 with each other. In a case where the information regarding the weight of each component is held in the E-BOM 121, the serial number BOM registration unit 16 may register the information regarding the weight of each component in the serial number BOM 131.

The serial number BOM 131 represents a completion drawing of a serial number. The completion drawing is a drawing representing a completed form of a product. For this reason, for example, in a case where a completion drawing is necessary as a drawing of a manufactured product, the person in charge of the design category can more accurately and effectively create a book by using the serial number BOM 131.

For example, in a case where the association system 3 is a system in a supply category, a person in charge of the supply category can easily perform management of component arrangements of each serial number by associating arrangement information and the serial number BOM 131 with each other. Examples of the arrangement information include a management number of an instruction for arrangement in the component arrangements, an ordering situation, and the date of delivery. The person in charge of the supply category can easily create an arrangement BOM for managing arrangement information for each serial number by using the serial number BOM 131. The person in charge of the supply category can easily ascertain a starting date of the use of each component and can timely supply components in association with a production schedule by the arrangement BOM. This leads to minimization of components in stock, and thus it is possible to reduce an in-process cost.

For example, in a case where the association system is a system in a manufacturing category, a person in charge of the manufacturing category can easily create a manufacturing BOM (M-BOM) for each serial number by associating a manufacturing process, a manufacturing procedure, or other pieces of manufacturing information with the serial number BOM 131. In this case, the M-BOM is created on the basis of the serial number BOM 131. For this reason, the person in charge of the manufacturing category can accurately and effectively manage a change measure even when design is changed during the manufacture.

For example, in a case where the association system 3 is a system in a quality control category, a person in charge of the quality control category can accurately and effectively perform the control of quality for each serial number by associating a serial number, test records, or other pieces of quality control information with the serial number BOM 131. For this reason, the person in charge of the quality control category can effectively trace the quality control information of each serial number and can precisely perform the control of quality.

For example, in a case where the association system 3 is a system in an after-sales service category, a person in charge of the after-sales service category can effectively perform the maintenance of each serial number by associating a maintenance period, durable years, or other pieces of maintenance information with the serial number BOM 131. Further, the person in charge of the after-sales service category can ascertain a component configuration of a serial number, having been subjected to the replacement of a component due to repair or the like, for each user by user information and the serial number BOM 131 being associated with each other. This is a large appeal point in terms of after-sales service.

### Modification Example

Information regarding a drawing version number may be stored in the E-BOM 121. In this case, the serial number BOM registration unit 16 acquires the latest drawing version number from the E-BOM 121. The serial number BOM registration unit 16 may construct the serial number BOMs 131-1 to 131-n by registering the drawing version number acquired from the E-BOM 121 in the serial number BOM 131.

A unit provided with a serial number BOM is not limited for each serial number of a product. For example, a serial number BOM may be provided for each lot of products. In this manner, a serial number BOM is provided in units larger than each serial number of a product, and thus it is possible to reduce the number of serial number BOMs to be managed. Such a serial number BOM provided for each lot is called a lot BOM. The serial number BOM or the lot BOM may be reproduced as needed. The serial number BOM or the lot BOM are reproduced, and thus it is possible to flexible cope with a case where it is necessary to divide a BOM due to a change in design within the same lot. That is, in this case, a user can start operation from an initial state constituted by one serial number BOM or one lot BOM. Thereby, the user can start the operation of the serial number BOM or the lot BOM with a small amount of data.

Although some embodiments of the invention have been described above, these embodiments are described as examples, and do not intend to limit the scope of the invention. These embodiments may be embodied in other various modes, and may be variously omitted, substituted, and modified without departing from the scope of the invention. These embodiments and modification thereof are within the scope and the gist of the invention, and are within the scope of the invention described in the scope of claims and the equivalent thereof.

### INDUSTRIAL APPLICABILITY

According to the invention, a user can easily ascertain contents of a change in design which was performed in the past.

### REFERENCE SIGNS LIST

1 COMPONENT TABLE MANAGEMENT SYSTEM
11 COMMUNICATION UNIT
12 E-BOM STORAGE UNIT
121 E-BOM (ENGINEERING BILL OF MATERIALS)
1211 PRODUCT NUMBER MASTER
1212 CONFIGURATION MASTER
13 SERIAL NUMBER BOM STORAGE UNIT
131, 131-1 TO 131-N SERIAL NUMBER BOM
1311 UPDATE DEADLINE MASTER
1312 PRODUCT NUMBER VERSION NUMBER MASTER
1313 SERIAL NUMBER CONFIGURATION MASTER
14 INPUT UNIT
15 E-BOM REGISTRATION UNIT
16 SERIAL NUMBER BOM REGISTRATION UNIT
161 FIRST DETERMINATION UNIT
162 SECOND DETERMINATION UNIT
163 THIRD DETERMINATION UNIT
17 BOM INFORMATION PROVIDING UNIT
2 DESIGN DRAWING MANAGEMENT SYSTEM
21 DESIGN DRAWING
3 ASSOCIATION SYSTEM

1. A component table management system comprising:
a first storage unit that stores a main component table holding design information of products;
a second storage unit that stores a sub-component table holding the design information of the products and an update deadline of the design information for each predetermined unit of the products manufactured on the basis of the same design information;
a first determination unit that determines whether or not the main component table has been changed; and
a second determination unit that determines whether or not a present date is before the update deadline,
wherein in a case where the first determination unit determines that the main component table has been changed and the second determination unit determines that the present date is before the update deadline, the second determination unit reflects contents of the change performed on the main component table on the sub-component table.

2. The component table management system according to claim 1, further comprising:
a third determination unit that determines whether or not permission information for permitting a change after the update deadline has been input to the sub-component table,
wherein in a case where the first determination unit determines that the main component table has been changed, the second determination unit determines that the present date is after the update deadline, and the third determination unit determines that the permission information has been input, the third determination unit reflects contents of the change performed on the main component table on the sub-component table.

3. The component table management system according to claim 1,
wherein the sub-component table further holds information regarding a version number of the design information.

4. The component table management system according to claim 1,
wherein the second storage unit stores the sub-component table for each individual of the products.

5. The component table management system according to claim 1,
wherein the second storage unit stores the sub-component table for each lot of the products.

6. The component table management system according to claim 1, further comprising:
a providing unit that provides information held in the main component table or the sub-component table to an external system.

7. A component table management method performed by a component table management system including a first storage unit that stores a main component table holding design information of products, and a second storage unit that stores a sub-component table holding the design information of the products and an update deadline of the design information for each predetermined unit of the products manufactured on the basis of the same design information, the method comprising:
determining whether or not the main component table has been changed;
determining whether or not a present date is before the update deadline; and
reflecting contents of the change performed on the main component table on the sub-component table in a case where it is determined that the main component table has been changed and it is determined that the present date is before the update deadline.
